(19) United States
(12) Patent Application Publication
(10) Pub. No.: US 2009/0177583 A1
(43) Pub. Date: Jul. 9, 2009

(54) MEDIA RENTING SYSTEM, MEDIA RENTAL PROVIDER AND METHOD

(75) Inventors: Yu-Zhang Wen, Shenzhen City (CN); Zai-An Pan, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/344,459

(22) Filed: Dec. 27, 2008

(30) Foreign Application Priority Data
Jan. 3, 2008 (CN) 200810300011.6

(51) Int. Cl. H04L 9/32; H04N 7/173; G06Q 30/00; G06Q 20/00

(52) U.S. Cl. 705/52; 725/98; 705/58

(57) ABSTRACT

A media renting system includes a media rental provider and a client machine. The provider communicates with the client machine via a data transmission network. The provider stores user information including a payment card number of a user and a hardware ID of the client machine. In a related media renting method, when the user information from the client machine is recorded in the provider, the client machine succeeds to rent the media file and displays the media file. When rental fees of the media file are greater than or equal to a purchase price of the media file, the provider deducts the purchase price from a balance of the payment card and binds the media file to the client machine.

### TECHNICAL FIELD

The invention relates to media renting and, more particularly, to a media renting system, a media rental provider, and a media renting method adapted for the media renting system.

### GENERAL BACKGROUND

Commonly, people purchase information and entertainment media from brick and mortar stores in the form of books, digital video disks, and the like. However, it is now becoming more popular to shop for such items on the Internet. Although Internet shopping is convenient and even includes home delivery and payment services using electronic commerce technology, it can still be expensive.

Therefore, people are turning more frequently to media rental services to rent movies, books etc. However, customers of media rental providers must remember when they rented from these service providers, or face paying costly fines and not saving any money after all. Some customers may in fact end up paying more than they would have paid had they just purchased the rented item.

Accordingly, what is needed in the art is a media renting system and method that overcome the aforementioned deficiencies.

### BRIEF DESCRIPTION OF THE DRAWINGS

The components in the drawings are not necessarily drawn to scale, the emphasis instead being placed upon clearly illustrating the principles of the media renting system and method. Moreover, in the drawings, like reference numerals designate corresponding parts throughout the several views.

FIG. 1 is a block diagram of a media renting system in accordance with an exemplary embodiment.

FIG. 2 is a block diagram of hardware infrastructure of a client machine of the media renting system of FIG. 1, in accordance with an exemplary embodiment.

FIG. 3 is a flowchart of a registration procedure of the media renting system of FIG. 1, in accordance with an exemplary embodiment.

FIG. 4 is a schematic diagram of a user information list of the media renting system of FIG. 1, in accordance with an exemplary embodiment.

FIG. 5 is a flowchart of a media renting method that can be carried out by employing the media renting system of FIG. 1, in accordance with an exemplary embodiment.

FIG. 6 is a schematic diagram of a rental prompt user interface of the client machine of FIG. 2, in accordance with an exemplary embodiment.

FIG. 7 is a schematic diagram of another rental prompt user interface of the client machine of FIG. 2, in accordance with an exemplary embodiment.

FIG. 8 is a flowchart of a media return method that can be carried out by employing the media renting system of FIG. 1, in accordance with an exemplary embodiment.

### DETAILED DESCRIPTION OF EMBODIMENTS

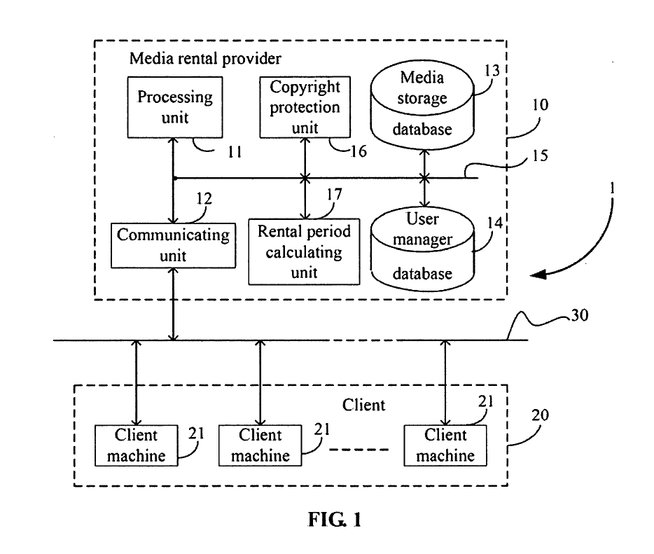

FIG. 1 is a block diagram of a media renting system in accordance with an exemplary embodiment. The media renting system 1 includes a media rental provider 10 (hereinafter “provider 10”), a client 20, and a data transmission network 30 (e.g., the Internet). The provider 10 communicates with the client 20 and distributes media files to the client 20 via the data transmission network 30. The media files may be text data, audio data, video data, or other media files. The client 20 includes at least one client machine 21. In the illustrated embodiment, there are several client machines 21. Each client machine 21 is an electronic apparatus, such as an e-book reader, a notebook computer, and the like.

The provider 10 includes a processing unit 11, a communicating unit 12, a media storage database 13, a user manager database 14, a data bus 15, a copyright protection unit 16, and a rental period calculating unit 17. In general, the provider 10 is comprised of a server and a plurality of computers (not shown). The media storage database 13 stores a plurality of media files. The copyright protection unit 16 is configured for encrypting the media files using digital rights management (DRM) technology and generating download keys associated with the media files. In the exemplary embodiment, each download key is comprised of a hardware identification (ID) of the client machine 21 and a serial number of the media file rented by the client machine 21. Accordingly, the copyright protection unit 16 authorizes the client machine 21 to open media files and prevents the media files from being illegally copied by other client machines 21.

The data bus 15 is configured for providing a channel to transmit data, for example, the media files. The processing unit 11 is configured for encoding and compressing the media files in response to input operations from the client machine 21, and controlling the provider 10. The communicating unit 12 is configured for receiving signals from the client 20, and sending the media files to the client 20 according to controls of the processing unit 11. The rental period calculating unit 17 is configured for measuring an elapsed time of a rental period of a media file. The user manager database 14 is configured for storing a plurality of user information records. Each of the user information records includes a user name, a password, an identification (ID) number of the user, a payment card number, and a hardware ID of a client machine 21.

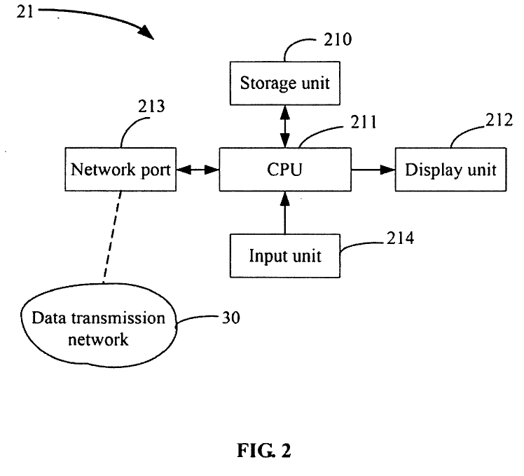

FIG. 2 is a block diagram of hardware infrastructure of a client machine 21 of the media renting system of FIG. 1, in accordance with an exemplary embodiment. The client machine 21 includes a central processing unit (CPU) 211, a display unit 212, a storage unit 210, a network port 213, an input unit 214, and a rental period calculating unit 215. The input unit 214 is configured for receiving input operations generated by a user. The rental period calculating unit 215 is configured for measuring an elapsed time of a rental period of a media file. The storage unit 210 is configured for storing the media files transmitted from the provider 10. The network port 213 is configured for connecting the client machine 21 to the data transmission network 30. The CPU 211 is configured for processing the input operations from the user and controlling the client machine 21. The display unit 212 is configured for displaying information, such as a web site, a media file, and the like.

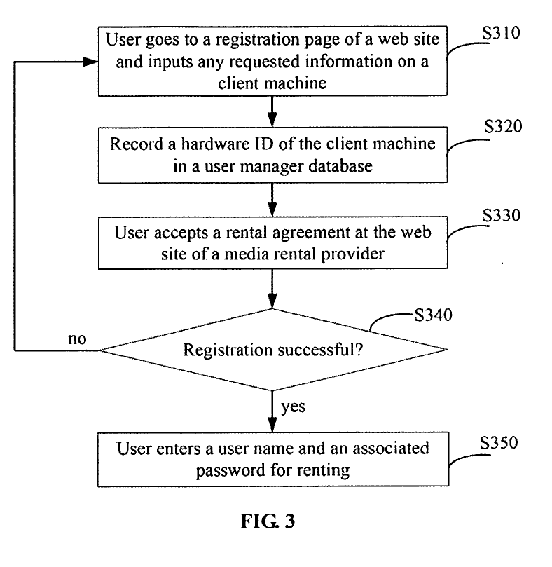

Before the client machine 21 rents a media file from the provider 10 for the first time, the user must register at a web site of the provider 10. FIG. 3 is a flowchart of a registration procedure of the media renting system of FIG. 1 in accordance with an exemplary embodiment. In step S310, the user goes to a registration page of the web site of the provider 10 using the display unit 212, and inputs any requested information using the input unit 214. The requested information includes, but is not limited to, a user name, a password, an identification (ID) number of the user, and a payment card number. In step S320, the provider 10 records the hardware ID of the client machine 21 and stores the user name, the password, the ID number of the user, the payment card number, and the hardware ID of the client machine 21 as the user information in the user manager database 14.

In step S330, the user accepts a rental agreement at the web site of the provider 10. In step S340, upon successful completion of these registration steps, which may require additional steps such as verification of the user information by the provider 10, and a username and password availability check, etc., the process goes to step S350, otherwise goes to step S310. In step S350, the user inputs his user name and password to enter the portion of the web site of the provider 10 for selecting media files for renting.

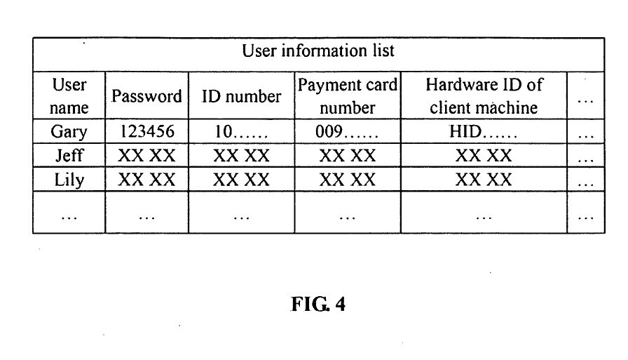

The user manager database 14 stores a user information list. As shown in FIG. 4, the user information list stores a plurality of user information records. In the illustrated embodiment, the user information list includes a “user name” column, a “password” column, an “ID number” column, a “payment card number” column, and a “hardware ID of client machine” column. The “user name” column records a plurality of user names, such as Gary, Jeff, Lily, and the like. The “password” column records a plurality of passwords. The “ID number” column records a plurality of ID numbers. The “payment card number” column records a plurality of payment card numbers. The “hardware ID of client machine” column records a plurality of hardware IDs of the client machines 21.

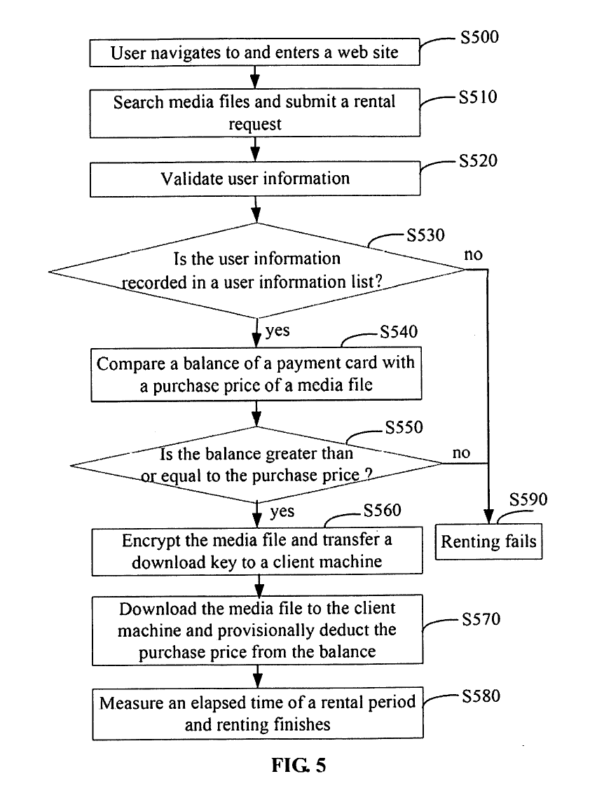

FIG. 5 is a flowchart of a media renting method that can be carried out by employing the media renting system 1, in accordance with an exemplary embodiment. When the user wants to rent a media file from the provider 10 via the data transmission network 30, in step S500, the user navigates to and enters the web site of the provider 10, and the renting procedure starts. In step S510, the user searches media files and selects a desired media file at the web site, and submits a rental request to the provider 10 via the client machine 21. In step S520, the communicating unit 12 receives the rental request and acquires the user information from the client machine 21, and the processing unit 11 validates the user information. In step S530, the processing unit 11 determines whether the user information from the client machine 21 is recorded in the user information list in the user manager database 14. That is, the processing unit 11 determines whether the user is an eligible user registered in the provider 10. If the user information is not recorded in the user information list, that is, the user is an ineligible user, then in step S590, the renting procedure fails.

If the user information is recorded in the user information list, that is, the user is an eligible user, in step S540, the processing unit 11 compares a balance of the payment card of the user with a purchase price of the desired media file. In step S550, if the purchase price of the desired media file is greater than the balance of the payment card, then in step S590, the renting procedure fails.

In contrast, if the balance of the payment card is greater than or equal to the purchase price of the media file in step S550, then the renting procedure succeeds, and in step S560, the copyright protection unit 16 encrypts the media file using DRM technology and the communicating unit 12 transfers the download key to the client machine 21. In the exemplary embodiment, the download key is comprised of the hardware ID of the client machine 21 and the serial number of the media file. In step S570, the processing unit 11 downloads the media file to the client machine 21 and provisionally deducts the purchase price from the balance of the payment card. Typically, at a later date, the final determined rental fees are taken from the provisional deduction and credited to the provider 10, and any remainder of the provisional deduction is credited back to the payment card (see below). In step S580, the rental period calculating unit 17 of the provider 10 and the rental period calculating unit 215 of the client machine 21 synchronously measure an elapsed time of the rental period of the media file, and the renting procedure finishes.

After the renting procedure finishes, the client machine 21 stores and displays the media file associated with the download key, and the user accesses the media file on the display unit 212. When the user has accessed the media file for a predetermined time period, that is, the client machine 21 has stored the media file for the predetermined time period, the CPU 211 generates a rental prompt user interface on the client machine 21. The rental prompt user interface is a reminder for the user.

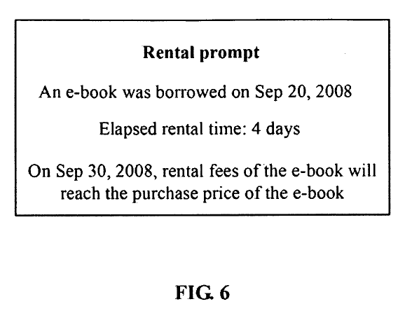

FIG. 6 is a schematic diagram of a rental prompt user interface of any client machine 21, in accordance with an exemplary embodiment. As shown, the rental prompt user interface is a rental prompt about renting an e-book. The illustrated rental prompt of the e-book includes three items. The first item is “an e-book was borrowed on Sep. 20, 2008;” that is, the client machine 21 stored the e-book on Sep. 20, 2008. The second item is “elapsed rental time is 4 days;” that is, the client machine 21 has stored the e-book in the storage unit 210 for 4 days. The third item is “on Sep. 30, 2008, rental fees of the e-book will reach the purchase price of the e-book;” that is, the CPU 211 calculates the rental fees of the e-book according to the elapsed rental time from the rental period calculating unit 215 and generates the content of this item of the prompt.

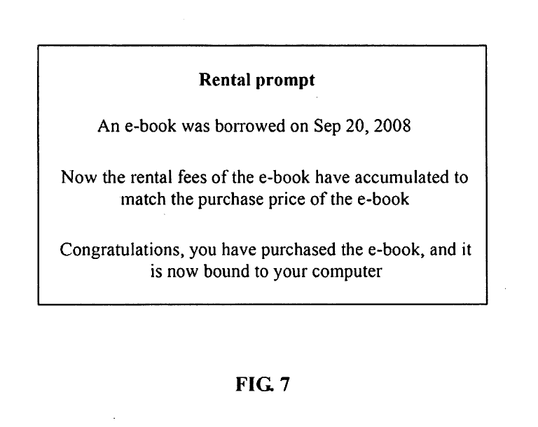

When the rental fees of the e-book accumulate enough to match the purchase price of the e-book, the CPU 211 generates another rental prompt on the display unit 212. In the embodiment as shown in FIG. 7, the rental prompt user interface includes three items. The first item is the same as the first item in the rental prompt shown in FIG. 6 (see also above). The second item is “now the rental fees of the e-book have accumulated to match the purchase price of the e-book;” that is, the CPU 211 calculates the elapsed time since the renting of the e-book according to the rental period calculating unit 215. The third item is “Congratulations, you have purchased the e-book, and it is now bound your computer;” that is, the client machine 21 may keep the e-book, as it is now a purchased media file and not a rented one. Thereafter, the user may freely read the e-book at any time on the client machine 21.

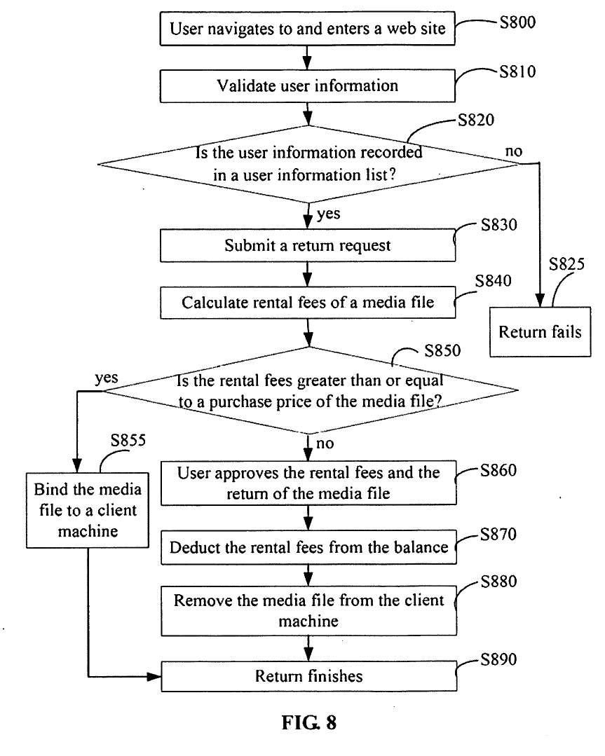

FIG. 8 is a flowchart of a media return method that can be carried out by employing the media renting system 1, in accordance with an exemplary embodiment. When the user wants to return a media file, in step S800, the media return procedure starts, and the user navigates to and enters the web site of the provider 10 using his username and password. The communicating unit 12 acquires the user information from the client machine 21, in step S810, and the processing unit 11 validates the user information. In step S820, the processing unit 11 determines whether the user information from the client machine 21 is recorded in the user information list in the user manager database 14. If the user information is not recorded in the user information list, in step S825, the media return procedure fails, that is, the user is ineligible.

In contrast, if the user information is recorded in the user information list in the user manager database 14 in step S820, that is, the user is eligible, then in step S830, the user submits a return request on the client machine 21 to the provider 10. In step S840, the communicating unit 12 receives the return request, the rental period calculating unit 17 calculates the elapsed time since the beginning of the rental of the media file, and the processing unit 11 calculates the rental fees of the media file according to the elapsed time. In step S850, the processing unit 11 determines whether the rental fees of the media file are greater than or equal to the purchase price of the media file. If yes, in step S855, the processing unit 11 binds the media file to the client machine 21 as a purchased item, and permanently keeps the purchase price of the media file previously deducted from the payment card at the time of initial rental. In step S890, the media return procedure finishes. In contrast, if the rental fees of the media file are less than the purchase price of the media file in step S850, then in step S860, the user approves the amount of the rental fees of the media file and the return of the media file. In step S870, the processing unit 11 deducts the rental fees of the media file from the amount previously charged to their balance at time of initial rental, and credits the difference to the payment card. In step S880, the processing unit 11 removes the media file from the client machine 21. In step S890, the return procedure finishes. It is understood that the above-described embodiments may be implemented in other forms without departing from the spirit of the present invention. That is, the present examples and embodiments are to be considered in all respects as illustrative and not restrictive, and the invention is not to be limited to the details given herein.

What is claimed is:

1. A media renting system comprising:
a media rental provider and a client machine, wherein the media rental provider is capable of communicating with the client machine via a data transmission network;
the media rental provider comprising:
a media storage database, for storing a plurality of media files;
a copyright protection unit, for encrypting a media file and generating a download key of the media file;
a user manager database, for storing user information, the user information comprising a payment card number of a user and a hardware identification (ID) of the client machine;
a communicating unit, for receiving signals from the client machine and sending an encrypted media file to the client machine;
a rental period calculating unit, for measuring an elapsed time of a rental period of a media file; and
a processing unit, for:
downloading a media file with the download key to the client machine when the user information from the client machine is recorded in the user manager database;
calculating a rental fee of the media file according to the elapsed time received from the rental period calculating unit; and
when the rental fee is greater than or equal to a purchase price of the media file, binding the media file to the client machine and deducting the purchase price from a balance of the payment card of the user; or
when the rental fee is less than the purchase price of the media file, removing the media file from the client machine and deducting the rental fee from the balance of the payment card;
and the client machine comprising:
an input unit, for generating input operations by the user;
a display unit, for displaying the media file according to the download key of the media file; and
a central processing unit (CPU), for responding to the media rental provider and controlling the client machine according to the input operations from the input unit.

2. The media renting system as recited in claim 1, wherein the media files comprise at least one item selected from the group consisting of text data, audio data, and video data.

3. The media renting system as recited in claim 1, wherein the user information further comprises at least one item selected from the group consisting of a user name, a password, and an ID number.

4. The media renting system as recited in claim 1, wherein the download key is comprised of the hardware ID of the client machine and a serial number of the media file rented by the client machine.

5. The media renting system as recited in claim 1, wherein the CPU is configured to generate a rental prompt user interface on the display unit when the elapsed time has reached a predetermined time value.

6. A media rental provider configured for communicating with a client machine via a data transmission network, the media rental provider comprising:
a media storage database, for storing a plurality of media files;
a copyright protection unit, for encrypting a media file and generating a download key of the media file;
a user manager database, for storing user information, the user information comprising a payment card number of a user and a hardware identification (ID) of the client machine;
a communicating unit, for receiving signals from the client machine and sending the media file to the client machine;
a rental period calculating unit, for measuring an elapsed time of a rental period of a media file; and
a processing unit, for:
downloading a media file to the client machine when the user information from the client machine is recorded in the user manager database;
calculating a rental fee of the media file according to the elapsed time received from the rental period calculating unit; and
when the rental fee is greater than or equal to a purchase price of the media file, binding the media file to the client machine and deducting the purchase price from a balance of the payment card of the user; or
when the rental fee is less than the purchase price of the media file, removing the media file from the client machine and deducting the rental fee from the balance of the payment card.

7. The media rental provider as recited in claim 6, wherein the media files comprise at least one item selected from the group consisting of text data, audio data, and video data.

8. The media rental provider as recited in claim 6, wherein the user information further comprises at least one item selected from the group consisting of a user name, a password, and an ID number.

9. The media rental provider as recited in claim 6, wherein the download key is comprised of the hardware ID of the client machine and a serial number of the media file rented by the client machine.

10. A media renting method for a media renting system, wherein the media renting system comprises a media rental provider and a client machine, the media rental provider is capable of communicating with the client machine via a data transmission network, and the media rental provider stores user information comprising a payment card number of a user and a hardware ID of the client machine, the method comprising:
navigating to and entering a web site of the media rental provider on the client machine via the data transmission network;
validating the user information from the client machine;
comparing a balance of the payment card with a purchase price of a media file, if the user information is recorded in the media rental provider; and
if the balance of the payment card is greater than or equal to the purchase price of the media file, encrypting the media file and generating a download key of the media file;
measuring an elapsed time of a rental period of the media file and calculating a rental fee of the media file; and
if the rental fee of the media file is greater than or equal to the purchase price of the media file, deducting the purchase price from the balance of the payment card, and binding the media file to the client machine; or
if the rental fee of the media file is less than the purchase price of the media file, deducting the rental fee from the balance of the payment card, and removing the media file from the client machine.

11. The media renting method as recited in claim 10, wherein the media file comprises at least one of text data, audio data, and video data.

12. The media renting method as recited in claim 10, wherein the user information further comprises at least one item selected from the group consisting of a user name, a password, and an identification (ID) number.

13. The media renting method as recited in claim 10, wherein the download key is comprised of the hardware ID of the client machine and a serial number of the media file rented by the client machine.

14. The media renting method as recited in claim 12, further comprising: registering and inputting any requested information at the web site of the media rental provider.

15. The media renting method as recited in claim 10, further comprising: storing and displaying the media file on the client machine, when the user information is recorded in the media rental provider.

16. The media renting method as recited in claim 15, further comprising: generating a rental prompt user interface on the client machine, when the elapsed time has reached a predetermined value.
